(19) United States
(12) Patent Application Publication
(10) Pub. No.: US 2024/0207789 A1
(43) Pub. Date: Jun. 27, 2024

(54) PREVENTIVE CONTROL METHOD AND SYSTEM FOR PREVENTING THE FOULING OF A MEMBRANE SEPARATION UNIT

(71) Applicant: SUEZ INTERNATIONAL, PARIS LA DEFENSE CEDEX (FR)

(72) Inventors: Emmanuelle FILLOUX, Clichy (FR); Anne BREHANT, Nanterre (FR); Céline LEVECQ, CHATOU (FR); Véronique BONNELYE, Conflans Sainte Honorine (FR); Raphaëlle DU BESSET, PARIS (FR)

(73) Assignee: SUEZ INTERNATIONAL, PARIS LA DEFENSE CEDEX (FR)

(21) Appl. No.: 18/288,724

(22) PCT Filed: Apr. 28, 2022
(86) PCT No.: PCT/FR2022/050808

§ 371 Date: Oct. 27, 2023

(30) Foreign Application Priority Data
Apr. 29, 2021 (FR) FR2104506
Feb. 16, 2022 (FR) FR2201344

(51) Int. Cl. B01D 65/08; B01D 61/04; B01D 61/12

(52) U.S. Cl. CPC B01D 65/08; B01D 61/04; B01D 61/12; B01D 2311/04; B01D 2311/12; B01D 2311/18; B01D 2313/701; B01D 2321/16; B01D 2321/40

(57) ABSTRACT

The invention relates to a method and a system for controlling a membrane separation unit of an aqueous liquid effluent treatment plant comprising a system for injecting at least one chemical compound into the effluent to be treated. The method and the system allow regulating at least one parameter selected from an amount of chemical compound(s) to be added and a conversion rate in order to avoid clogging and/or precipitation of ionic species in the retentate. This regulation uses optimum setpoint values determined according to one or more parameter(s) characteristic of the retentate and not of the water to be treated. Thus, an accurate regulation of the amount of chemical compound(s) to be added and/or of the conversion rate of the membrane separation unit at an optimum value allowing at the same time avoiding clogging and/or precipitation of the species likely to precipitate and minimising the operating costs is achieved.

### FIELD OF INVENTION

The invention relates to a method and a system for controlling a membrane separation unit, in particular by reverse osmosis or nanofiltration, of a water treatment plant. In particular, the invention relates to a method and system allowing operating a membrane separation unit without any risk of clogging and at a lower cost.

### PRIOR ART

Reverse osmosis is a membrane separation method which has attracted great interest in water treatment in recent years, for example in seawater desalination, brine water purification and drinking water production, as well as in industrial wastewater purification or the preparation of pure and ultrapure water preparation for various industrial applications.

In a reverse-osmosis system, the dissolved substances are removed from a usually aqueous medium, like an aqueous solution comprising one or more compound(s) dissolved in the latter in the form of ions, and are separated from the solvent by pressing said solution under high pressure through a semi-permeable membrane that enables solvent molecules to pass in a very selective manner through the membrane forming what is called permeate, substantially free of any impurities like dissolved ions initially present in the feed solution. Impurities are retained in a concentrate, called retentate (or concentrate), which is consequently richer in dissolved matter than the feed solution.

A recurring problem associated with long-term continuous operation of reverse-osmosis systems is the control, or rather the prevention, of deposits in the system, in particular deposits forming over the surface of the membrane facing the retentate. Besides the so-called “fouling” or “clogging”, i.e. the deposition of suspended organic matter, colloids and microorganisms over the membrane, “scaling”, i.e. the formation of inorganic precipitates, is a major cause of the formation of such deposits. Both phenomena, fouling and scaling, tend to block the membrane for solvent molecules. This results in a reduction in the permeate flow rate in the system, a reduction in the selectivity of the system, an increase in energy costs, a reduction in membrane purification cycles and a reduction in its service life.

The term “scaling” refers to the formation of inorganic deposits by precipitation occurring when the concentration of some salts more or less soluble in water, like for example CaCO₃, Ca₂(PO₄)₃, alkaline-earth metal sulphates, in particular CaSO₄, BaSO₄ and SrSO₄, and/or some silicates and the same, in the retentate, exceeds the solubility limit of these salts. The concentration of ionic particles retained in the retentate is particularly high in the water located immediately proximate to the membrane surface, where it may be up to 20% higher than in the retentate.

In general, in order to avoid precipitation and clogging of the membrane system, precipitation inhibitor chemical compounds (often referred to as “anti-scaling agent”) are added to the water to be treated and the pH is adjusted, most often by adding acid. Furthermore, the permeate recovery rate is adjusted so that the maximum concentrations of salts likely to precipitate remain below the solubility limit in the retentate.

Precipitation inhibitors are compounds that interfere with, or disrupt, the crystal growth of compounds likely to precipitate. These compounds act either by forming relatively soluble complexes with the ions likely to precipitate, or by dispersing the compounds of the precipitation.

In general, the applied dosage of the precipitation inhibitors and/or acid is calculated based on a chemical analysis of the mean composition of the aqueous feed medium. Commonly used calculation methods only take into account some model parameters for scale formation, for example the saturation index (SI) of the compounds likely to precipitate present in the feed medium and its pH, but ignore other parameters that are often too complex to be accessible. Hence, conventional dosage of precipitation inhibitors is rather inaccurate and an excessive amount of precipitation inhibitors and/or acid is generally used to avoid scaling of the membrane system. While they allow of a safe operation of membrane separation systems, these overfills have a considerable impact on the operating costs of these separation systems as well as on the permeate post-treatment costs (by re-mineralization).

The document WO2006/128730 describes a method for treating an aqueous medium using reverse osmosis wherein the presence of particles of compounds likely to precipitate in the retentate is continuously monitored by measuring the turbidity or by counting the number of particles having a specific size, data on these particles are compared with data determined experimentally beforehand for a similar aqueous medium under similar operating conditions and a precipitation inhibitor is added when the data originating from the continuous monitoring differ from the experimental data. This method has the drawback of detecting particles of compounds likely to precipitate. However, the presence of these particles means that precipitation has begun: the described method therefore does not allow preventing precipitation but limiting it, which may prove insufficient. Furthermore, the comparative data are based on experimental data obtained from the same aqueous medium to be treated, under identical operating conditions: these experimental data might not limit precipitation upon a variation in the composition of the aqueous medium to be treated, to the extent that the latter is not monitored.

Clogging and scaling problems are observed for both reverse-osmosis and nanofiltration membrane separation systems.

Hence, there is still a need for a method allowing injecting minimum amounts of precipitation inhibitors and/or acid to reliably prevent a precipitation of the species likely to precipitate. There is also a need to optimise operating costs, preferably taking into account the post-treatment costs.

### SUMMARY OF THE INVENTION

The invention relates to a method and a system for controlling a membrane separation unit of an aqueous liquid effluent treatment plant. A membrane separation unit receives the effluent to be treated and produces a retentate and a permeate. The method and control system of the invention, intended to control a membrane separation unit comprising a system for injecting at least one chemical compound into the effluent to be treated, allow regulating at least one parameter selected from an amount of chemical compound(s) to be added and a conversion rate in order to avoid clogging and/or precipitation of ionic species in the retentate. This regulation uses optimum setpoint values determined according to one or more characteristic parameter(s) of the retentate.

By determining a setpoint value according to a characteristic parameter of the retentate rather than the water to be treated, the control method and system according to the invention allow accurately regulating the amount of chemical compound(s) to be added and/or the conversion rate of the membrane separation unit, at an optimum value allowing avoiding clogging and/or precipitation of species likely to precipitate and at the same time minimising the operating costs. Thus, the control method and system according to the invention allow adjusting the operating parameters of the membrane separation unit before the occurrence of clogging and/or precipitation phenomena, in particular before the formation of particles of compounds likely to precipitate, thereby ensuring a reliable operation over the service life of the membrane separation unit and the increase of its service life, while limiting the operating costs.

In particular, by selecting as a characteristic parameter of the retentate, the pH, a chemical parameter for measuring the concentration of the oxonium ion H₃O⁺ in an aqueous solution, the invention allows achieving regulation even before the formation (and therefore the possible detection) of particles of compounds likely to precipitate, with the aforementioned advantages.

### Definitions

The conversion rate is usually defined as the ratio of the permeate flow rate to the total feed flow rate of the membrane separation unit. The conversion rate allows characterising the hydraulic operation of the plant.

By “current value” of a parameter, it should be understood the last determined value of that parameter.

The membrane separation unit mentioned in the present invention may comprise one, two or more filtration stage(s), especially three stages, typically arranged in series. Each filtration stage produces a retentate and a permeate, the retentate of an upstream stage forming the effluent to be treated of the downstream stage. Each filtration stage is composed of one or more membrane module(s), typically connected in series and/or in parallel. For example, membrane modules and FILMTEC® filtration modules could be used.

By “effluent to be treated”, it should be understood an aqueous liquid effluent to be treated such as raw water (surface water or groundwater), seawater, brine water, urban effluents, industrial effluents, the retentate of one or more of the filtration stages of a multi-stage membrane separation unit, alone or in mixtures. In particular, the retentate coming out of the membrane separation unit (on one or more stage(s)) may be recycled at the inlet of the latter.

### DETAILED DESCRIPTION OF THE INVENTION

A first object of the invention relates to a method for controlling a membrane separation unit of an aqueous liquid effluent treatment plant, the membrane separation unit receiving the effluent to be treated, producing a retentate and a permeate and comprising a system for injecting at least one chemical compound into the effluent to be treated. Optionally, the at least one chemical compound may be selected from a chemical compound allowing adjusting the pH, in particular an acid, and a precipitation inhibitor.

In the control method according to the invention:
(a) a value of the pH of the retentate is (directly or indirectly) measured,
(b) at least one optimum setpoint value is determined based on the measured value of the pH of the retentate to avoid clogging of the membrane separation unit and/or precipitation of ionic species initially present in the effluent to be treated in the retentate, selected from:
(i) a first setpoint value corresponding to a minimum amount of the at least one chemical compound to be added to the effluent to be treated for a current conversion rate of the membrane separation unit,
(ii) a second setpoint value corresponding to a maximum conversion rate with no added chemical compound,
(iii) a pair of a third and fourth setpoint values corresponding to a minimum amount of the at least one chemical compound to be added to the effluent to be treated combined with a maximum conversion rate,
(c) said at least one optimum setpoint value is applied to the corresponding parameter of the membrane separation unit.

The method according to the invention allows regulating at an optimum value at least one of the aforementioned parameters, namely the amount of chemical compound to be added and/or the conversion rate, at a specific setpoint value based on the measured value of the pH of the retentate and optionally other parameters of the retentate or of the effluent to be treated described below. In other words, the invention allows regulating the amount of chemical compound to be added and/or the conversion rate by using only the measured value of the pH of the retentate, and optionally at least one other parameter selected, in particular only, from the conductivity of the retentate, a concentration of at least one ionic species likely to precipitate in the retentate, the temperature of the retentate and the temperature of the effluent to be treated. Other parameters allowing detecting the presence of particles in the retentate, such as the turbidity, or counting the number of particles are not used in the present invention because detection/counting particles means that precipitation has already begun.

When the membrane separation unit comprises two or more stages, the retentate a value of the pH of which is measured in step (a) of the method according to the invention is the retentate derived from the last stage of the membrane separation unit. Advantageously, the effluent to be treated may be the effluent entering the membrane separation unit and/or the retentate derived from one or more of the stages located upstream of the last stage of the membrane separation unit.

The membrane separation unit may further comprise a retentate recirculation loop, in particular the retentate derived from the last membrane stage when the unit is a multi-stage one, at the inlet of the membrane separation unit. This recirculation allows optimising the remineralization of the permeate but increases the risk of clogging of the membrane separation unit, the latter being controllable by the implementation of the method and control system according to the invention. In particular, the recirculation may be controlled based on conductivity or another quality parameter of the permeate coming out of the membrane separation unit.

A first setpoint value corresponds to a minimum amount of chemical compound to be added to the effluent to be treated to avoid clogging of the membrane separation unit and/or precipitation of ionic species initially present in the effluent in the retentate for the current operating parameters, in particular for the current conversion rate. In other words, this means adding an amount of chemical compound that is just enough to prevent clogging and/or precipitation, without excess, under operating conditions defined by the current conversion rate of the membrane separation unit.

In general, one or more chemical compound(s) may be added to this end to the effluent to be treated. Thus, one or more first setpoint value(s) may be determined. The chemical compound may be selected indifferently from a chemical compound allowing adjusting the pH and a precipitation inhibitor.

Nonetheless, advantageously, when the determined setpoint value is an amount of chemical compound to be added to the effluent, a setpoint value for at least one chemical compound allowing adjusting the pH, and optionally a setpoint value for at least one precipitation inhibitor, could be primarily selected. The pH may be adjusted by adding a base or an acid. In particular, an acidic pH promotes the solubility of calcium carbonate type salts, often present in the aqueous effluents to be treated. Most often, the chemical compound allowing adjusting the pH will thus be a compound allowing adjusting the pH to an acidic pH (pH below 7), such as an acid or CO₂. Inorganic acids (for example, hydrochloric acid (HCl), nitric acid (HNO₃), sulphuric acid (H₂SO₄), phosphoric acid (H₃PO₄), and organic acids such as formic acid (CH₂O₂), acetic acid (CH₃COOH), sulphamic acid (H₃NSO₃) are examples of acids likely to modify the pH.

A precipitation inhibitor is a chemical compound allowing inhibiting the precipitation of at least one chemical species such as calcium carbonate, calcium sulphate, sulphates of other alkaline-earth metals, calcium phosphate, calcium fluoride, silica.

In particular, usable precipitation inhibitors include so-called threshold inhibitors, i.e. chemical compounds that delay or disrupt the growth phase of crystallisation and thus inhibit the formation of crystals, either by preventing the formation of seed crystals large enough to precipitate the solution or by causing distortion of the crystals, thereby leaving fluffy amorphous crystallites that remain in suspension and/or are easily dissolved so that they could be easily removed. Some precipitation inhibitors further include dispersing agents that create a charge at the surface of the crystallites and thereby keep the particles in suspension.

The person skilled in the art will be able to determine the precipitation inhibitors to be used according to the nature of the ionic species likely to precipitate present in the retentate and originating from the effluent to be treated.

Examples of compounds useful as precipitation inhibitors include polyphosphates, like sodium hexametaphosphate, polyphosphonates, like nitrilotrimethylenetriphosphonic acid (CAS No. 6419-19-8), diethylenetriamine-pentamethylenephosphonic acid, (DTPMP, CAS No. 15827-60-8), 2-phosphonobutane-1, 2,4-tricarboxylic acid (PBTC, CAS No. 37971-36-1) and 1-hydroxyethane-1,1-diphosphonic acid) (HEDP, CAS No. 2809-21-4). Other examples of precipitation inhibitors are based on polymers of polyacrylic acid (PAA), polymethacrylic acid (PMAA) and/or polymaleic acid (PMA). Polyacrylic acids with a molar mass of 1,000 to 3,000 g/mol are useful because of their threshold effect; a molar mass of 5,000 to 10,000 g/mol because of their ability to cause a distortion effect; and a molar mass of 20,000 g/mol and more, for example 20,000 to 40,000 g/mol as dispersing agents. Many useful compounds like precipitation inhibitors such as those mentioned before are commercially available, for example by the company ROPUR AG.

A second setpoint value corresponds to a maximum conversion rate of the membrane separation unit avoiding (preventing) clogging of the membrane separation unit and/or precipitation of ionic species initially present in the effluent to be treated in the retentate, with no added chemical compound. In other words, this is the highest conversion rate for which no clogging/precipitation is observed.

Thus, in some cases, the sole control of the conversion rate may actually allow maintaining the concentration of the species likely to precipitate in the retentate at a level below the precipitation threshold, namely below the solubility limit. In general, this will depend on the nature of the chemical species likely to precipitate present in the effluent to be treated and on their concentrations.

Finally, a pair of a third and fourth setpoint values may be determined. These setpoints correspond to a minimum amount of the at least one chemical compound to be added to the effluent to be treated in combination with a maximum conversion rate, this combination allowing avoiding clogging of the membrane separation unit and/or precipitation of ionic species in the retentate. In other words, it is a matter of determining an amount of the at least one chemical compound that is just enough to avoid clogging for a highest possible conversion rate. This allows optimising both the added amount of chemical compound(s) and the conversion rate.

For example, the pair of the third and fourth setpoint values may be selected according to one or more of the following elements: desired permeate flow rate, amount of effluent to be treated (for example amount needed to obtain a particular yield of the separation unit), maximum acceptable discharge rate, maximum acceptable concentration of a compound in the effluent, regulations, content of a compound/element that the precipitation inhibitors cannot control well (silica, Al, Fe), operating costs, in particular pre-treatment costs (cost of the effluent to be treated) and/or power consumption and/or cost of the added chemical compounds and/or subsequent post-treatment costs.

In particular, the second setpoint value or the pair of the third and fourth setpoint values could be determined based on at least one setpoint value of an operating cost, in particular a post-treatment cost of at least one flow selected from the retentate and the permeate, while preferably seeking the best tradeoff in terms of operating cost/yield of the separation unit, and in particular in terms of the cost of the added chemical compounds/yield of the separation unit. Indeed, depending on the nature and amount of added chemical compound(s), it may turn out to be necessary to treat the retentate and/or permeate coming out of the membrane separation unit, which may substantially increase the overall cost of treatment of the effluent. Typically, the post-treatment of the retentate may consist of a dilution or a concentration possibly with recovery of the minerals. In general, the post-treatment of the permeate is intended to make it non-corrosive or to remineralise it or disinfect it. Thus, when determining the second setpoint value or the pair of the third and fourth setpoint values based on at least one setpoint value of an operating cost, it is possible to determine the second setpoint value or the pair of the third and fourth setpoint values for which a setpoint value of an operating cost is achieved. This operating cost setpoint value may correspond to:
for the second setpoint value, at a maximum conversion rate of the membrane separation unit wherein no chemical compound is added, for which post-treatment of the produced permeate and/or retentate is the least costly in terms of chemical products consumption and/or energy consumption,
for the pair of the third and fourth setpoint values, to a minimum amount of the at least one chemical compound to be added to the effluent to be treated combined with a maximum conversion rate for which a post-treatment of the produced permeate and/or retentate is the least costly in terms of chemical products consumption and/or energy consumption.

The choice between the optimum setpoint values as defined in points (i), (ii) and (iii) of the method according to the invention may depend on regulatory or contractual requirements and any requirements in terms of costs, in particular according to the ionic composition of the effluent and the temperature. Conducting tests will enable the person skilled in the art to select the most appropriate optimum setpoint value or pair of optimum setpoint values.

Once the previously described optimum setpoint value(s) have been determined during step (b), this value (or these values) may then be applied to the corresponding parameter of the membrane separation unit during step (c).

A control loop formed by reiterating the steps of the control method during operation of the membrane separation unit may be provided for in order to avoid any risk of clogging and/or precipitation of the unit over time.

In one embodiment, steps (b) and (c) may be implemented at each measurement of the value of the pH of the retentate. It is then possible to proceed with an iteration of steps (a) to (c).

In another embodiment, steps (b) and (c) may be implemented only when the value of the pH of the retentate measured in step (a) varies. In particular, this allows simplifying regulation and making it quicker. It is then possible to proceed with an iteration of step (a), then verify at each iteration during a step (a′) whether the value of the pH of the retentate measured in step (a) reaches at least a predetermined threshold value or varies by at least a predetermined amount, then implement steps (b) and (c) when said at least a predetermined threshold value or predetermined amount is reached. In particular, one or more predetermined threshold value(s) or one or more predetermined amount(s) could be provided for, for example to detect more or less large and/or rapid variations in the pH of the retentate. This may allow determining different setpoint values according to the urgency of the situation, a very large and/or rapid variation in the pH reflecting a sudden/rapid modification of the effluent requiring a rapid action. Thus, these predetermined threshold values or amounts could be determined according to the frequency of iteration of step (a), in particular according to a pH measurement frequency. This frequency could be selected in order to enable an adjustment of the setpoint value(s) determined in step (b) allowing taking into account any variations in the quality of the effluent to be treated over time.

In general, when there is iteration of step (a) or steps (a) to (c), the measured value of a parameter taken into account for step (b) is the current value of this parameter.

In general, the determination of the variation of a parameter may be carried out in a conventional manner by comparing the current value of the parameter with the value of the same parameter measured during the previous iteration of step (a) or steps (a) to (c). Thus, a variation in the pH of the retentate could typically be observed as of the second iteration of step (a) or steps (a) to (c).

Advantageously, during step (a), the value of at least one other parameter of the retentate selected, in particular only, from the conductivity and a concentration of at least one ionic species likely to precipitate could be (directly or indirectly) measured. Henceforth, during step (b), the at least one setpoint value is determined based on the measured value of the pH of the retentate and the measured value of the at least one other parameter of the retentate.

In order to simplify regulation, this other parameter could be taken into account only when a variation in this parameter is determined, for example during step (a′). Then, advantageously, during step (b), the at least one setpoint value could be determined based on the measured value of the pH of the retentate and the measured value of the at least one other parameter of the retentate for which a variation is determined.

This allows improving the accuracy of the control of the membrane separation unit by modifying the setpoint value(s) only when a variation in the conductivity or concentration of ionic species likely to precipitate is detected, i.e. when a variation in the composition of the effluent to be treated and consequently of the retentate is detected.

For example, a variation of the parameter may be considered to be determined when this parameter varies by a predetermined amount or when it reaches a predetermined threshold value.

In particular, when a variation is determined for both the value of the conductivity and for a concentration of at least one ionic species likely to precipitate, said at least one setpoint value could be determined based on the measured value of the pH of the retentate and the measured value of said at least one concentration for which a change has been determined. In other words, the determination of the setpoint value(s) is prioritised based on the value of the pH and of the concentration, which allows for a better accuracy in the determination of the setpoint value.

Typically, the ionic species likely to precipitate include calcium ion, carbonate ion (HCO₃⁻), magnesium ion, sulphate ion (SO₄²⁻), silicon ion, barium ion, strontium ion, manganese ion, iron II ion, iron III ion, aluminium ion, and fluoride ion. Also, advantageously, a concentration of at least one of these ionic species in the retentate could be determined during step (a).

Advantageously, during step (a), at least one temperature selected from the temperature of the effluent to be treated and the temperature of the retentate could be measured, and during step (b), said at least one setpoint value could be determined based on the measured value of the pH, the measured value of the at least one determined temperature, and optionally the measured value of the selected at least one other retentate parameter, in particular only, from the conductivity and a concentration of at least one ionic species likely to precipitate.

In particular, said at least one setpoint value could advantageously be determined when a variation in at least one of these parameters is detected. Thus, during step (b), the optimum setpoint value of the amount of chemical compound(s) to be added and/or the conversion rate may be determined:
Case 1: either based only on the measured value of the pH of the retentate,
Case 2: or based on:
   the measured value of the pH of the retentate, and
   the measured value of at least one other parameter of the retentate (conductivity, concentration of an ionic species likely to precipitate),
Case 3: or based on:
   the measured value of the pH of the retentate, and
   the measured value of at least one temperature selected from the temperature of the retentate and the temperature of the effluent to be treated,
Case 4: or based on:
   the measured value of the pH of the retentate, and
   the measured value of at least one temperature selected from the temperature of the retentate and the temperature of the effluent to be treated, and
   the measured value of at least one other parameter of the retentate (conductivity, concentration of an ionic species likely to precipitate).

Each case could be selected depending on the specificities of the treatment plant, in particular the quality of the effluent to be treated and the variations in this effluent. Typically, case 1 is suitable for treating any type of effluent and any type of plant. Case 2 may be more particularly suitable for groundwater treatment. Case 3 may be more particularly suitable for the treatment of surface water or “reuse” (reuse for industrial purposes or potabilisation of wastewater once treated). Case 4 may be more suitable for more complex plants, for example treating different types of effluents (multi-source plants). Conducting tests will enable the person skilled in the art to select one of the aforementioned cases.

In particular, in each of these cases, at least one setpoint value could be determined in step (b) when a variation in at least one of these parameters is detected. In particular, priority could be given to determining this setpoint value as already described.

Advantageously, for a better prevention of clogging and/or precipitation, during step (a), the pH of the retentate, and optionally the at least other parameter of the retentate and/or the at least one temperature, could be measured by in-line measurements, i.e. in real-time. Preferably, at least one measurement selected from a pH measurement, a conductivity measurement, and a temperature measurement, consists of an in-line measurement carried out by means of a sensor.

In general, the determination step (a) could consist of an in-line measurement step, in particular for the determination of one or more of the following parameters: pH of the retentate, temperature of the retentate, conductivity of the retentate, temperature of the effluent to be treated, concentration of one or more ionic species in the retentate.

In general, the setpoint value(s) determined during step (b) may be extracted from a database built during a prior step of building an optimum setpoint value database. This database associates one or more setpoint value(s) with sets of parameter values, these parameters comprising the pH of the retentate, at least one operating parameter of the same membrane separation unit, and optionally at least one other parameter selected, in particular only, from the temperature of the retentate, the temperature of the effluent to be treated, the conductivity of the retentate and a concentration of at least one species likely to precipitate in the retentate. Typically, the operating parameter of the same membrane separation unit is the conversion rate of this unit.

This database may be built while taking into account some or all of the operating costs of the plant (pre-treatment costs, electrical costs, post-treatment costs).

This prior step may be an experimental, empirical determination step or a combination of both.

In particular, this prior step may comprise building a matrix, which:
comprises a plurality of retentate classes, each retentate class being defined by a value of the pH of the retentate and optionally by at least one other parameter of the retentate (in particular selected, in particular only, from conductivity, temperature, concentration of ionic species likely to precipitate) or of the effluent to be treated (temperature), in particular for operating parameters of the membrane separation unit other than those of the setpoint value(s) to be determined,
associates at least one of the setpoint values as previously described with each retentate class.

In general, the control method according to the invention could comprise a regulation step during which at least the conversion rate of the membrane separation unit is regulated at an initial setpoint value and optionally an amount of at least one chemical compound to be added to the effluent to be treated at an initial setpoint value. This regulation step is typically carried out before step (a) of the method.

During this step, it could be provided for regulating one or more other operating parameter(s) of the separation unit at an initial setpoint value. These other operating parameters are typically the pressure of the effluent to be treated, the flow rate of the effluent to be treated, the pressure of the retentate, the temperature of the effluent to be treated, the flow rate of the permeate, the differential pressure. The regulation of these other operating parameters may be performed conventionally by means of one or more regulation loop(s) receiving data provided by sensors of these other operating parameters provided at suitable locations of the membrane separation unit, the regulation loop(s) acting on means for adjusting these parameters. This or these regulation loop(s) may be incorporated into the control system of the invention.

In general, the initial setpoint value(s) correspond(s) to values set upon start-up of the membrane separation unit. These initial setpoint values may be determined in the usual way (by calculations and/or empirically) depending on the effluent to be treated and the other parameters usually taken into account by the operators, i.e. permeate flow rate, retentate flow rate, pressure of the effluent to be treated, pressure drop. In general, the initial setpoint value of the conversion rate and of the other operating parameters is therefore different from zero. On the other hand, the initial setpoint value of the amount of at least one chemical compound to be added may be zero.

The method according to the invention may be implemented for the treatment of an aqueous liquid effluent containing in particular one or more chemical species likely to precipitate, for example those previously listed. This aqueous liquid effluent may be selected from raw water (surface water or groundwater), seawater, brine water, urban effluents, industrial effluents, and two or more of these effluents. These effluents contain more than 50 vol % water, usually more than 60 vol % water. In some cases, the water content may be at least 95%, and possibly at least 99%, for example up to 99.9%, and possibly up to 100%. The water content may be within any range defined by the aforementioned limits. In general, the remaining percentages are solids, such as particles, suspended matter, colloids, etc.

Another object of the invention is a computer program comprising instructions for executing the steps of the control method according to the invention, when said instructions are executed by one or more processor(s). Indeed, the control method according to the invention may be implemented by computing means such as a processor, for example a microprocessor, a microcontroller or the like.

Another object of the invention is a computer-readable medium on which the computer program of the invention is stored.

By “computer-readable medium”, it should be understood any memory, any storage device, any storage mechanism and any other storage and signalling mechanism, including interfaces and devices such as network interface boards and buffer memories contained therein, as well as any communication device and any received and transmitted signal, and any other current and evolving technology that a computerised system could interpret, receive and/or transmit. This concept includes not only a computer-readable medium such as a hard disk connected to a central unit and with which the recorded program is executed directly, but also a computer-readable medium such as a CD-ROM which records a program to be executed after it has been installed on a hard disk. A program herein comprises not only a program that may be executed directly, but also a program in source format, a compressed program and an encrypted program.

In particular, the control method according to the invention may be implemented by means of the control system of the invention described hereinafter.

Another object of the invention relates to a control system of a membrane separation unit of an aqueous liquid effluent treatment plant, the membrane separation unit receiving the effluent to be treated, producing a retentate and a permeate and comprising a system for injecting at least one chemical compound into the effluent to be treated.

The control system of the invention comprises:
first means for adjusting the conversion rate of the membrane separation unit,
second means for adjusting an amount of at least one chemical compound to be added to the effluent to be treated,
a means for measuring the pH of the retentate,
calculation and transmission means connected to the means for measuring the pH of the retentate.

In general, the calculation and transmission means are programmed to implement the steps previously described with reference to the method according to the invention.

According to the invention, the calculation and transmission means are programmed to:
(a) receive a measured value of the pH of the retentate from the pH measuring means,
(b) calculate, based on the measured value of the pH of the retentate, at least one optimum setpoint value to avoid clogging of the membrane separation unit and/or precipitation of ionic species initially present in the effluent to be treated in the retentate,
said at least one setpoint value being selected from:
(i) a first setpoint value corresponding to a minimum amount of the at least one chemical compound to be added to the effluent to be treated for a current conversion rate,
(ii) a second setpoint value corresponding to a maximum conversion rate of the membrane separation unit with no added chemical compound,
(iii) a pair of a third and fourth setpoint values corresponding to a minimum amount of the at least one chemical compound to be added to the effluent to be treated combined with a maximum conversion rate,
(c) transmit said at least one calculated setpoint value to the corresponding adjustment means.

The first means for adjusting the conversion rate of the membrane separation unit may comprise one or more of the following adjustment means: a means for adjusting the flow rate of the effluent to be treated entering the membrane separation unit, a means for adjusting the flow rate of the permeate, a means for adjusting the flow rate of the retentate, a means for adjusting the pressure of the effluent to be treated. These adjustment means may consist of a pump, a flowmeter, a valve or the same.

The second adjustment means may comprise means for adjusting the flow rate of the at least one chemical compound to be added, such as a pump, a flowmeter, a valve or a combination thereof, in particular connected to a supply pipe or a tank containing the chemical compound.

For example, the means for measuring the pH of the retentate is a pH meter.

The calculation and transmission means may comprise one or more processor(s), for example microprocessors or microcontrollers. Communication means, optionally bidirectional, may be provided between the calculation and transmission means and the first and second adjustment means and/or between the different measuring means described.

Advantageously, the calculation and transmission means of the control system according to the invention may be programmed to determine the second setpoint value or the pair of the third and fourth setpoint values based on at least one setpoint value of an operating cost, in particular a post-treatment cost of at least one flow selected from the retentate and the permeate, and preferably based on setpoint values of the different operating costs, as described with reference to the method.

Advantageously, the calculation and transmission means of the control system according to the invention may be programmed:
to receive a plurality of measurements of the pH of the retentate, particularly successive over time,
to verify at each received new measurement whether the measured value of the pH of the retentate reaches at least one predetermined threshold value or varies by at least one predetermined amount, then,
to calculate said at least one setpoint value and transmit it to the corresponding adjustment means when said at least one predetermined threshold value or predetermined amount is reached.

Other parameters may be taken into account for the determination of the setpoint value(s). Thus, advantageously, the control system may further comprise:
second means for measuring the value of at least one other parameter of the retentate selected, in particular only, from the conductivity and a concentration of at least one ionic species likely to precipitate, and the calculation and transmission means may be programmed:
to receive from the second measuring means a measured value of at least one other parameter of the retentate, optionally to determine a variation in the measured value of the at least one other parameter of the retentate, and
to calculate the at least one setpoint value based on the measured value of the pH of the retentate and the measured value of the at least one other retentate parameter, optionally based on the measured value of the at least one other parameter for which a variation is determined.

Henceforth, it is possible to prioritise the parameters to be used for the calculation of the setpoint value(s), for example by programming the calculation and transmission means, when a variation is determined for both the measured value of the conductivity and of at least one concentration of at least one ionic species likely to precipitate, to calculate said at least one setpoint value based on the measured value of the pH of the retentate and the measured value of said at least one concentration for which a change has been determined.

The second measuring means may comprise means for (directly or indirectly) measuring a concentration of at least one ionic species selected from a calcium ion, a carbonate ion, a magnesium ion, a sulphate ion, a silicon ion, a barium ion, a strontium ion, a manganese ion, an iron II ion, an iron III ion, an aluminium ion, a fluoride ion. In particular, these second measuring means may comprise metering means.

Advantageously, the control system according to the invention may comprise third means for measuring at least one temperature selected from the temperature of the effluent to be treated and the temperature of the retentate. The calculation and transmission means may then be programmed to calculate said at least one setpoint value based on the measured value of the pH of the retentate and the measured value of the at least one temperature. The calculation and transmission means may be programmed to determine a variation in at least one of these parameters and to calculate said at least one setpoint value when a variation of at least one of these parameters is determined.

This embodiment could be combined with the embodiment comprising second means for measuring the value of at least one other retentate parameter selected, in particular only, from the conductivity and a concentration of at least one ionic species likely to precipitate, and wherein said calculation and transmission means are programmed to calculate the at least one setpoint value based on the measured value of the pH of the retentate and the measured value of the at least one other parameter of the retentate.

Advantageously, the calculation and transmission means may be programmed to determine a variation in at least one of these parameters, namely the pH of the retentate, the temperature of the retentate, the temperature of the effluent, and optionally conductivity and/or concentration of at least one ionic species likely to precipitate, and to calculate said at least one setpoint value when a variation in at least one of these parameters is determined. As described before, when a variation is determined for both the conductivity and a concentration of at least one ionic species likely to precipitate, then the setpoint value could be calculated based on the measured value of the pH of the retentate, the measured value of at least one temperature, and the measured value of the concentration of at least one ionic species likely to precipitate for which a variation has been determined.

In general, the means for measuring the pH of the retentate and optionally at least one of the mentioned second and third measuring means may consist of in-line measuring means. Preferably, an in-line measurement of one or more of the following parameters could be performed: pH of the retentate, temperature of the retentate, conductivity of the retentate, temperature of the effluent to be treated and concentration of one or more ionic species in the retentate.

The calculation and transmission means of the control system according to the invention may also be programmed to determine and transmit to the first adjustment means at least one initial setpoint value of the conversion rate of the membrane separation unit and optionally to determine and transmit to the second adjustment means an amount of at least one chemical compound to be added to the effluent to be treated at an initial setpoint value. These initial setpoint values could be selected as described with reference to the method according to the invention. Furthermore, other operating parameters of the membrane separation unit than those mentioned may be regulated at initial setpoint values. These parameters have been listed with regards to the method. Their regulation may be obtained in the usual way by one or more regulation loops receiving information provided by sensors of these parameters positioned in appropriate locations of the membrane separation unit and connected to means for adjusting these parameters, these loops being able to be incorporated into the control system of the invention.

In general, the calculation and transmission means of the control system according to the invention may also be programmed to calculate a setpoint value based on a database of setpoint values of the same type as that one described with reference to the method and/or in the description of the figures and established for the membrane separation unit to be controlled. In particular, this database could be recorded in a memory of the calculation and transmission means.

Another object of the invention relates to an aqueous liquid effluent treatment plant having a control system according to the invention, this treatment plant including a membrane separation unit receiving the effluent to be treated, producing a retentate and a permeate and comprising a system for injecting at least one chemical compound into the effluent to be treated. When the membrane separation unit comprises two or more stages, in particular three, the injection system may be configured to inject at least one chemical compound into the effluent to be treated, namely the effluent entering the membrane separation unit and/or the retentate derived from a stage located upstream of the last stage and/or the retentate derived from each of the stages located upstream of the last stage.

Finally, the invention relates to the use of a control method according to the invention to prevent clogging of an aqueous liquid effluent treatment plant including a membrane separation unit receiving the effluent to be treated, producing a retentate and a permeate and comprising a system for injecting at least one chemical compound into the effluent to be treated.

### DESCRIPTION OF FIGURES

The invention is now described with reference to the appended, non-limiting drawing, wherein:

FIG. 1 is a schematic illustration of a membrane separation unit equipped with a control system according to the invention.

FIG. 2 is a schematic illustration of a membrane separation unit with three filtration stages equipped with a control system according to the invention.

FIG. 3 is a schematic illustration of a membrane separation unit with three filtration stages and addition of chemical compounds at each stage, equipped with a control system according to the invention.

FIG. 4 is a schematic illustration of a membrane separation unit with three filtration stages and retentate recirculation loop equipped with a control system according to the invention.

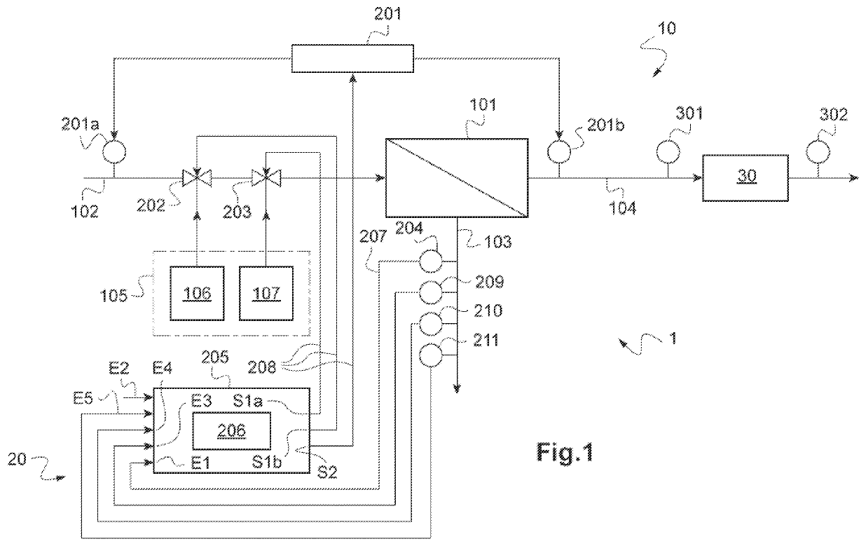

FIG. 1 schematically shows a membrane separation unit 10 forming part of an aqueous liquid effluent treatment plant 1. This membrane separation unit 10 comprises a membrane module 101, with a reverse osmosis membrane or with a nanofiltration membrane. Thus, this membrane separation unit 10 has only one single filtration stage composed of one single membrane module 101. Nonetheless, the invention is not limited by this embodiment and the unique stage could be composed of one or more membrane module(s), typically at least two membrane modules. A pipe 102 conveys the effluent to be treated to the membrane separation unit 10, more specifically to the membrane separation module 101, which produces a retentate and a permeate discharged via the pipes 103 and 104 respectively.

The membrane separation unit 10 also comprises a system 105 for injecting at least one chemical compound in the effluent to be treated. The latter comprises one or more chemical compound tank(s) in fluid connection with the pipe 102. FIG. 1 shows two tanks 106, 107, one for adding acid and one for adding a precipitation inhibitor. Of course, the invention is not limited by a particular number of tanks, nor by the nature of the chemical compounds to be added provided that they allow adjusting the pH or inhibiting precipitation. In general, at least one tank of a pH adjusting chemical compound could be provided, and optionally at least one tank of a precipitation inhibitor chemical compound.

The control system 20 according to the invention allows regulating the membrane separation unit in order to avoid degradation by clogging and/or precipitation of the membrane module 101. To this end, the control system 20 comprises:
means 201 for adjusting the conversion rate of the membrane separation unit,
means 202, 203 for adjusting an amount of at least one chemical compound to be added to the effluent to be treated,
a retentate pH sensor 204, herein a pH meter,
a regulation 205 comprising calculation and transmission means 206 connected to the pH sensor 204 by means of communication means 207, communication means 208 between the calculation means 206 and the adjustment means 201-203 to introduce the initial setpoint values and said at least one optimum setpoint value.

In particular, means 202, 203 for adjusting the added amount of chemical compound are provided for each of the chemical compound tanks. These adjustment means 202, 203 may comprise a pump, a flowmeter, a valve or a combination of these means.

In this example, the means for adjusting the conversion rate of the membrane separation unit comprise a means 201a for adjusting the flow rate of the effluent to be treated entering the membrane separation unit and a means 201b for adjusting the flow rate of the permeate. The means for adjusting the conversion rate also comprise a regulation loop 201 which acts on the adjustment means 201a, 201b so as to control the conversion rate in accordance with a setpoint value. These adjustment means 201a, 201b may be a pump, a flowmeter, a valve or the same. In one variant, the regulation of the conversion rate could be carried out directly by the regulation 205.

For example, the communication means 207, 208 consist of output or input/output interfaces. These may consist of wireless communication interfaces (Bluetooth, WI-FI or other) or connectors (network port, USB port, serial port, Firewire® port, SCSI port or other).

The calculation means 206 may consist of one or more processor(s), for example microprocessors or microcontrollers. The processor(s) may have storage means which may consist of a random-access memory (RAM), an electrically-erasable programmable read-only memory (EEPROM), a flash memory, an external memory, or other. Such storage facilities may store received data, a control model and one or more computer program(s), inter alia. The signal of the pH sensor 204 is sent to an input E1 of the regulation 205. Via an input E2, the regulation 205 may also receive an initial setpoint value for the conversion rate of the membrane separation unit and/or for an amount of chemical compound to be added to the effluent to be treated.

The control system may also comprise, as shown in the embodiment of FIG. 1, a temperature sensor 209, a conductivity sensor 210, and at least one analyser 211 capable of determining a concentration of at least one ionic species likely to precipitate. All of these different elements 209-211 are arranged on the retentate circulation pipe 103. Alternatively, the temperature sensor could be positioned on the circulation pipe 102 of the effluent to be treated or another temperature sensor could be provided on this pipe 102.

Each of the sensors and the analyzer 209-211 outputs a signal sent to an input E3, E4, E5 respectively of the regulation 205.

The calculation means 206 are programmed to implement the steps (a) to (c) of the method according to the invention.

In this example, they are programmed to regulate at least the conversion rate of the membrane separation unit at an initial setpoint value, typically different from zero, and possibly to regulate an amount of at least one chemical compound to be added to the effluent to be treated at a setpoint value, which may be zero. They may also be programmed to regulate at least one other operating parameter of the unit at an initial setpoint value or not, typically different from zero.

According to the invention, the calculation means 206 are programmed to determine at least one optimum setpoint value based on the current value of the pH of the retentate provided by the sensor 204. In the present example, these optimum setpoint values are also determined based on the current values of the temperature, the conductivity and an ionic species concentration as provided by the sensors and analyzers 209-211.

This optimum setpoint value may be as defined before at the points (i), (ii) and (iii) of the method.

Afterwards, the optimum setpoint value (or the pair of optimum setpoint values) thus determined is delivered on a dedicated output S1a, S1b and S2 of the regulation 205 connected by a conductor 208 to the input of each of the adjustment means 201-203.

These setpoint values may be extracted from a database built during a prior step of building a database by experimental and/or empirical methods.

For example, it is possible to create a classification of the retentates according to the following parameters: pH, temperature, conductivity, concentration of one or more ionic species likely to precipitate. In particular, this characterisation of the retentates may be carried out during tests of treatment of different effluents with the membrane separation unit which should be controlled.

Then, for each retentate class defined by a set of these parameters, optimum operating parameters of the membrane separation unit to be controlled allowing avoiding precipitation/clogging are determined experimentally and/or by calculations (for example based on solubility calculations). In particular, this optimisation of the parameters may take into account the cost of the chemical compound(s) to be added when such an addition is necessary to preserve the membrane separation unit, possibly in combination with a maximum conversion rate or a maximum conversion rate when no chemical compound is added. The optimisation may also take into account the costs of pre-treatment of the effluent to be treated, the energy costs, any costs of post-treatment of the permeate and/or of the retentate related to the addition of chemical compounds. Thus, the plant shown in FIG. 1 comprises, on the permeate discharge pipe 104, a post-treatment unit 30, and pH sensors 301 and 302 upstream and downstream of this post-treatment unit, with regards to the circulation of the permeate.

Thus, these optimum operating parameters comprise:
the minimum amount of at least one chemical compound to be added in an effluent to avoid clogging and/or precipitation, in particular for different conversion rates, or
the maximum conversion rate to avoid clogging and/or precipitation when no chemical compound(s) is/are added, or
a pair of a minimum amount of at least one chemical compound to be added and a maximum conversion rate to avoid clogging and/or precipitation.

This allows creating a matrix allowing associating a minimum amount, a maximum conversion rate or a pair of a minimum amount and a maximum conversion rate with a pH value of the retentate, and possibly with at least one other parameter of the retentate (conductivity, temperature, concentration of ionic species) or of the effluent to be treated (temperature).

Alternatively, the values of the following parameters could be collected for different retentates: pH, temperature, conductivity, concentration of one or more ionic species likely to precipitate. Afterwards, it is possible to:
calculate the saturation limits of the different species likely to precipitate according to the pH of the retentate, with no chemical compound being added,
calculate the saturation limits of the different species likely to precipitate according to the pH of the retentate, with addition of chemical compound,
carry out a simulation of the different operating conditions (including an amount of chemical compound to be added) according to the conversion rate and the pH of the retentate,
select the optimum simulation allowing limiting the addition of chemical compound and/or maximising the conversion rate while avoiding any risk of clogging and/or precipitation.

In general, the treatment plant could also be equipped with one or more system(s) for monitoring already known clogging/precipitation phenomena.

Such systems just complement the control system according to the invention to the extent that they allow detecting a precipitation and not predicting it.

For example, the turbidity of the retentate could also be controlled to detect any precipitation problem, but this parameter will not be used to control the amount of chemical compound to be added.

A sacrificial membrane unit identical to the membrane separation unit but operating at a higher conversion rate than the latter and whose degradation will be monitored, for example by controlling the pressure difference between the flow entering the sacrificial membrane unit and its retentate, could also be installed on a retentate bypass line. A method of this type is described in the document WO0228517A1.

Finally, a tool for monitoring the scaling of an energy recovery device (ERD “Energy Recovery Device”) could be used.

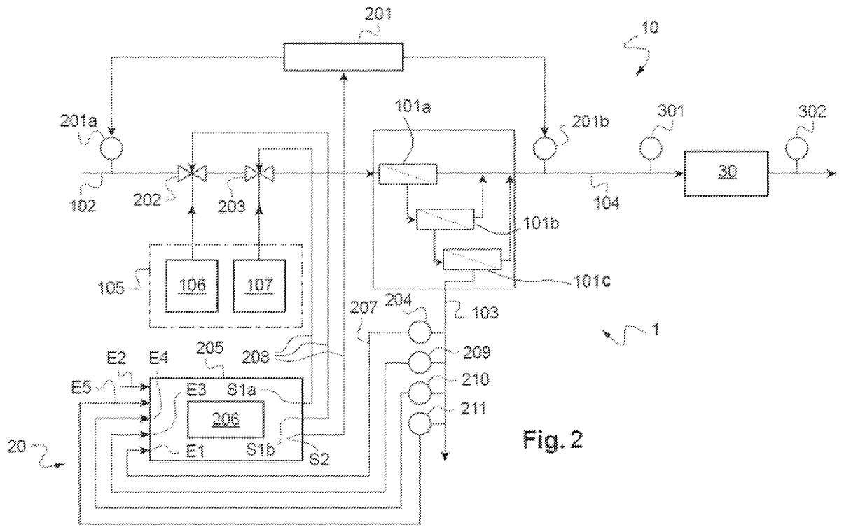

FIG. 2 shows a membrane separation unit 10 of a treatment plant 1 of an aqueous liquid effluent which differs from that one shown in FIG. 1 only in that the membrane separation unit comprises three filtration stages 101a, 101b, 101c, each filtration stage being possibly composed of one or more membrane module(s), typically at least two.

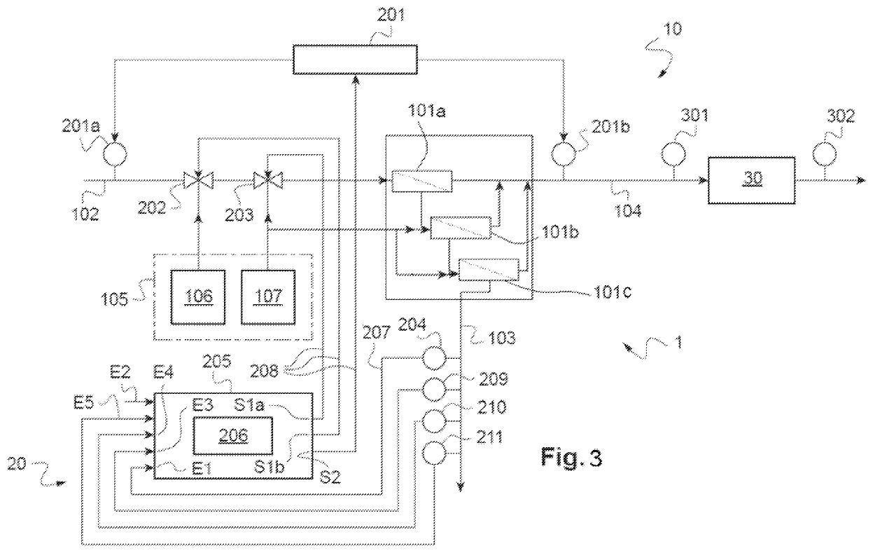

FIG. 3 shows a membrane separation unit 10 of an aqueous liquid effluent treatment plant 1 which differs from that one shown in FIG. 2 only in that an addition of at least one of the chemical compounds, herein that one of the tank 107, for example containing a pH adjusting chemical compound such as an acid, is sent to the inlet of the second stage 101b and/or to the inlet of the third stage 101c. The amounts of chemical compounds are then regulated thanks to the adjustment means similar to the previously-described means 202, 203 (not shown in the figures for clarity) also in communication with the calculation means 206. It should be noted that this configuration may allow optimising the chemical product consumption (in particular acid), with a reduction in consumption. For example, a reduction in consumption by 20 to 25% may be observed.

In this example, only the tank 107 containing a pH adjusting chemical compound feeds the stages 101b and 101c, it could nevertheless be provided that the chemical compound allowing inhibiting the precipitation of the tank 106 also feeds these stages.

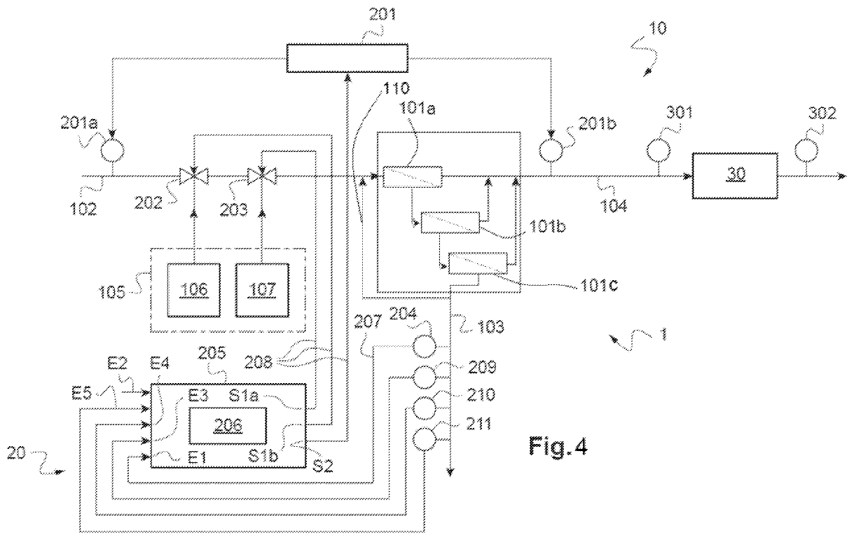

FIG. 4 shows a membrane separation unit 10 of an aqueous liquid effluent treatment plant 1 which differs from that one shown in FIG. 2 only in that a recirculation loop 110 returns the retentate coming out of the treatment unit (herein from the third filtration stage 101c) to the inlet of the treatment unit. Of course, this recirculation loop may be provided for regardless of the number of filtration stages of the membrane separation unit.

1. A method for controlling a membrane separation unit of an aqueous liquid effluent treatment plant, the membrane separation unit receiving the effluent to be treated, producing a retentate and a permeate and comprising a system for injecting at least one chemical compound into the effluent to be treated, wherein:
(a) a pH value of the retentate is measured,
(b) based on the measured pH value of the retentate, at least one optimum setpoint value is determined to avoid clogging of the membrane separation unit and/or precipitation of ionic species initially present in the effluent to be treated in the retentate and selected from:
(i) a first setpoint value corresponding to a minimum amount of the at least one chemical compound to be added to the effluent to be treated for a current conversion rate of the membrane separation unit,
(ii) a second setpoint value corresponding to a maximum conversion rate when no chemical compound is added,
(iii) a pair of a third and fourth setpoint values corresponding to a minimum amount of the at least one chemical compound to be added to the effluent to be treated combined with a maximum conversion rate,
(c) said at least one optimum setpoint value is applied to the corresponding parameter of the membrane separation unit.

2. The control method according to claim 1, wherein:
it is proceeded with an iteration of step (a),
at each iteration, it is verified during a step (a′) whether the value of the pH of the retentate measured in step (a) reaches at least one predetermined threshold value or varies by at least one amount, then predetermined
steps (b) to (c) are implemented when said at least one predetermined threshold value or predetermined amount is reached.

3. The control method according to claim 1, wherein:
during step (a), the value of at least one other parameter of the retentate selected from the conductivity and a concentration of at least one ionic species likely to precipitate is also measured,
optionally, a variation of the value of the at least one other parameter of the retentate is determined, and
during step (b), the at least one optimum setpoint value is determined based on the measured value of the pH of the retentate and the measured value of the at least one other parameter of the retentate, optionally based on the measured value of the at least one other parameter for which a variation is determined.

4. The control method according to claim 3, wherein when a variation is determined for both the value of the conductivity and for a concentration of at least one ionic species which is likely to precipitate, said at least one setpoint value is determined based on the measured value of the pH of the retentate and the measured value of said at least one concentration for which a variation has been determined.

5. The control method according to claim 3, wherein during step (a) a concentration of at least one ionic species selected from a calcium ion, a carbonate ion, a magnesium ion, a sulphate ion, a silicon ion, a barium ion, a strontium ion, a manganese ion, an iron II ion, an iron III ion, an aluminium ion, a fluoride ion is measured.

6. The control method according to claim 1, wherein:
during step (a), at least one temperature selected from the temperature of the effluent to be treated and the temperature of the retentate is measured, and
during step (b), said at least one setpoint value is determined based on the measured value of the pH of the retentate and the measured value of the at least one temperature.

7. The control method according to claim 1, wherein during step (a) the pH of the retentate is determined, and optionally the at least one other parameter of the retentate and/or the at least one temperature, by in-line measurements.

8. The control method according to claim 1, comprising a prior step of building up a database which associates one or more setpoint value(s) with sets of parameter values, these parameters comprising the pH of the retentate, at least one operating parameter of the same membrane separation unit, and optionally at least one other parameter selected from the temperature of the retentate, the temperature of the effluent to be treated, the conductivity of the retentate and a concentration in the retentate of at least one species likely to precipitate.

9. A computer program comprising the instructions for executing the steps of the control method according to claim 1, when said instructions are executed by one or more processor(s).

10. A computer-readable medium on which the computer program of claim 9 is stored.

11. A system for controlling a membrane separation unit of an aqueous liquid effluent treatment plant, the membrane separation unit receiving the effluent to be treated, producing a retentate and a permeate and comprising a system for injecting at least one chemical compound into the effluent to be treated, the control system comprising:
first means for adjusting the conversion rate of the membrane separation unit,
second means for adjusting an amount of at least one chemical compound to be added to the effluent to be treated,
a means for measuring the pH of the retentate,
calculation and transmission means connected to the means for measuring the pH of the retentate and programmed to:
(a) receive a measured value of the pH of the retentate from the pH measuring means,
(b) calculate based on the measured value of the pH of the retentate at least one optimum setpoint value to avoid clogging of the membrane separation unit and/or precipitation of ionic species initially present in the effluent to be treated in the retentate,
said at least one setpoint value being selected from:
(i) a first setpoint value corresponding to a minimum amount of the at least one chemical compound to be added to the effluent to be treated for a current conversion rate,
(ii) a second setpoint value corresponding to a maximum conversion rate of the membrane separation unit when no chemical compound is added,
(iii) a pair of a third and fourth setpoint values corresponding to a minimum amount of the at least one chemical compound to be added to the effluent to be treated combined with a maximum conversion rate,
(c) transmit said calculated setpoint value to the corresponding adjustment means.

12. The control system according to claim 11, characterised in that the calculation and transmission means are programmed:
to receive a plurality of measurements of the pH of the retentate,
to verify at each received new measurement whether the measured value of the pH of the retentate reaches at least one predetermined threshold value or varies by at least one predetermined amount, then,
to calculate said at least one setpoint value and transmit it to the corresponding adjustment means when said at least one predetermined threshold value or predetermined amount is reached.

13. The control system according to claim 11, characterised in that it further comprises:
second means for measuring the value of at least one other parameter of the retentate selected from the conductivity and a concentration of at least one ionic species likely to precipitate
and in that the calculation and transmission means are programmed:
to receive from the second measuring means a measured value of the at least one other parameter of the retentate,
optionally to determine a variation of the measured value of the at least one other parameter of the retentate and
to calculate the at least one setpoint value based on the measured value of the pH of the retentate and the measured value of the at least one other parameter of the retentate, optionally based on the measured value of the at least one other parameter for which a variation is determined.

14. The control system according to claim 13, wherein the calculation and transmission means are programmed, when a variation is determined for both the measured value of the conductivity and at least one concentration of at least one ionic species likely to precipitate, calculate said at least one setpoint value based on the measured value of the pH of the retentate and the measured value of said at least one concentration for which a variation has been determined.

15. The control system according to claim 13, wherein the second measuring means comprise means for measuring a concentration of at least one ionic species selected from a calcium ion, a carbonate ion, a magnesium ion, a sulphate ion, a silicon ion, a barium ion, a strontium ion, a manganese ion, an iron II ion, an iron III ion, an aluminium ion, a fluoride ion.

16. The control system according to claim 11, characterised in that it comprises:
third means for measuring at least one temperature selected from the temperature of the effluent to be treated and the temperature of the retentate,
and in that the calculation and transmission means are programmed to calculate said at least one setpoint value based on the measured value of the pH of the retentate and the measured value of the at least one temperature.
